(19) United States
(12) Patent Application Publication
(10) Pub. No.: US 2014/0176469 A1
(43) Pub. Date: Jun. 26, 2014

(54) APPARATUS AND METHOD FOR CONTROLLING DIM STATE

(71) Applicant: Pantech Co., Ltd., Seoul (KR)

(72) Inventor: Ha-Jung LIM, Seoul (KR)

(73) Assignee: Pantech Co., Ltd., Seoul (KR)

(21) Appl. No.: 14/132,699

(22) Filed: Dec. 18, 2013

(30) Foreign Application Priority Data
Dec. 20, 2012 (KR) 10-2012-0149591

(51) Int. Cl. G06F 3/041

(52) U.S. Cl. CPC G06F 3/0416
USPC 345/173

(57) ABSTRACT

A method for controlling a state of a display apparatus includes: controlling a light emitting portion to change a first portion of a display screen of the display apparatus to a first dim area; after changing the first portion to the first dim area, controlling the light emitting portion to change a second portion of the display screen of the display apparatus to a second dim area, the change of the second portion to the second dim area being associated with a termination time of a dim state; and controlling the light emitting portion to change the state of the display apparatus from the dim state to another state according to the termination time of the dim state.

### CROSS-REFERENCE TO RELATED APPLICATIONS

This application claims priority from and the benefit under 35 U.S.C. §119(a) of Korean Patent Application No. 10-2012-0149591, filed on Dec. 20, 2012, which is incorporated herein by reference for all purposes as if fully set forth herein.

### BACKGROUND

1. Field

The following description relates to a user interface of a touch interface apparatus, and more particularly, to a user interface apparatus and method using dimming of a touch screen.

2. Discussion of the Background

In a display apparatus using a backlight, such as an LED (Light Emitting Diode) or an LCD (Liquid Crystal Display) apparatus, adjusting the brightness of the backlight so that the brightness of the display apparatus gradually gets darker is referred to as dimming. If the display apparatus partially executes the dimming operation for a portion of a display screen, e.g., when it is necessary to dim not the full screen of the display screen but only a portion of the display screen, adjusting the brightness of the backlight for the portion of the screen is called a local dimming. If the display apparatus executes the dimming operation for the entire display screen, e.g., when it is necessary to dim the full screen, adjusting brightness of the backlight not only for a portion of the screen but for the full screen is called a global dimming.

Some apparatuses equipped with a touch screen interface control the screen to turn off and on through a dimming wait time and a screen hold time.

If an apparatus having a touch screen interface receives a key or a touch event while waiting during a set dimming wait time, the apparatus may wait for the dimming wait time again by resetting the dimming wait time. If the apparatus does not receive a key or touch event within the dimming wait time, the screen enters a dim state. Here, the dim state refers to a state in which the screen on the display is displayed but it is dimmed by e.g., adjusting the backlight. The apparatus having the touch screen interface may wait in the dim state for the screen hold time. If the apparatus receives a key or touch event during the screen hold time, the screen exits the dim state by turning on the backlight. On the other hand, if the apparatus does not receive the key or touch event during the screen hold time, the screen turns off. More specifically, if there is no key or touch input to the touch screen interface, the display of the screen in the dim state stops after a certain period of time and the screen turns off.

According to a method that turns off the display screen after a certain period of time in a dim state, after the full screen is dimmed and before it turns off, a user has to touch the touch screen interface or push a physical key to transmit a certain input to the apparatus in order to change the screen from the dim state to a normal state in which the backlight is fully turned on again. However, if the user inputs the touch or key event in order to exit the dim state and change the screen state to the normal state in which the backlight is fully turned-on, this may inadvertently activate an operation or a function of an application program or a home screen. Then, the user may need to touch the screen again in order to avoid unwanted operations caused by the inadvertently activated operation, thereby causing inconvenience for the user in using the apparatus. For example, if the screen of a smart phone becomes dim while watching the display screen, the user has to touch the screen or push the physical button in order to exit the dim state and recover the brightness of the screen. However, if the user touches the screen and pushes physical buttons randomly, an application program currently running, or an application associated with an icon on the screen, etc., can perform an unwanted operation in response to the touch input or the physical button input.

Further, when the user touches the screen in order to recover the brightness of the screen before changing from the dim state to an off state of the display screen, since it is difficult for the user to accurately predict the time remaining before changing from the dim state to the off state, the user may not touch the screen in the remaining time before the display switches off. If the display switches off, a specific touch input or physical input may be required in order to fully turn on the display screen again. For example, if the display of the smart phone switches off, the screen may only fully turn on again when a physical button such as the home button or a power button is pushed, and a lock interface for security may be executed if a screen lock function is set. Thus, the user may need to turn on the screen by pushing the home button or the power button and to unlock the lock interface in order to return to the application program that is running in the foreground.

### SUMMARY

Exemplary embodiments of the present invention provide a user interface apparatus and a method for controlling a dim state of a display screen.

Additional features of the invention will be set forth in the description which follows, and in part will be apparent from the description, or may be learned by practice of the invention.

Exemplary embodiments of the present invention provide a method for controlling a state of a display apparatus, the method including: controlling a light emitting portion to change a first portion of a display screen of the display apparatus to a first dim area; after changing the first portion to the first dim area, controlling the light emitting portion to change a second portion of the display screen of the display apparatus to a second dim area, the change of the second portion to the second dim area being associated with a termination time of a dim state; and controlling the light emitting portion to change the state of the display apparatus from the dim state to another state according to the termination time of the dim state.

Exemplary embodiments of the present invention provide a display apparatus to control a state of a display screen, including: a light emitting portion to emit a backlight, the light emitting portion being capable of generating a partial dim area on the display screen of the display apparatus, and a processor configured to control the light emitting portion to change a first portion of the display screen of the display apparatus to a first dim area. After the first portion is changed to the first dim area, the processor controls the light emitting portion to change a second portion of the display screen of the display apparatus to a second dim area, the change of the second portion to the second dim area being associated with a termination time of a dim state. The processor controls the light emitting portion to change the state of the display apparatus from the dim state to another state according to the termination time of the dim state.

Exemplary embodiments of the present invention provide a method for controlling a state of a display apparatus, the method including: controlling a light emitting portion to change a display screen to a dim state; indicating a state conversion area or a state conversion icon on the display screen during the dim state; receiving a user input on the state conversion area or the state conversion icon during the dim state; and changing the dim state into another state in response to the user input.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram showing a user interface apparatus for a dim state according to an exemplary embodiment of the present invention.

FIG. 2 is a flowchart showing a method of providing a user interface according to an exemplary embodiment of the present invention.

FIG. 3A, FIG. 3B, and FIG. 3C are diagrams showing a sequential expansion of a dim area of a user interface for a dim state according to an exemplary embodiment of the present invention.

FIG. 4A, FIG. 4B, and FIG. 4C are diagrams showing a gradual expansion of a dim area of a user interface for a dim state according to an exemplary embodiment of the present invention.

FIG. 5 is a diagram showing a gradual expansion of a dim area of a user interface for a dim state according to an exemplary embodiment of the present invention.

FIG. 6 is a diagram showing an additional information interface of a user interface for a dim state according to an exemplary embodiment of the present invention.

FIG. 7A and FIG. 7B are diagrams showing a state recovery icon displayed during a dim state according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments. Throughout the drawings and the detailed description, unless otherwise described, the same reference numerals will be understood to refer to the same respective elements, features, and structures. The relative size and depiction of these elements may be exaggerated for clarity, illustration, and convenience.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

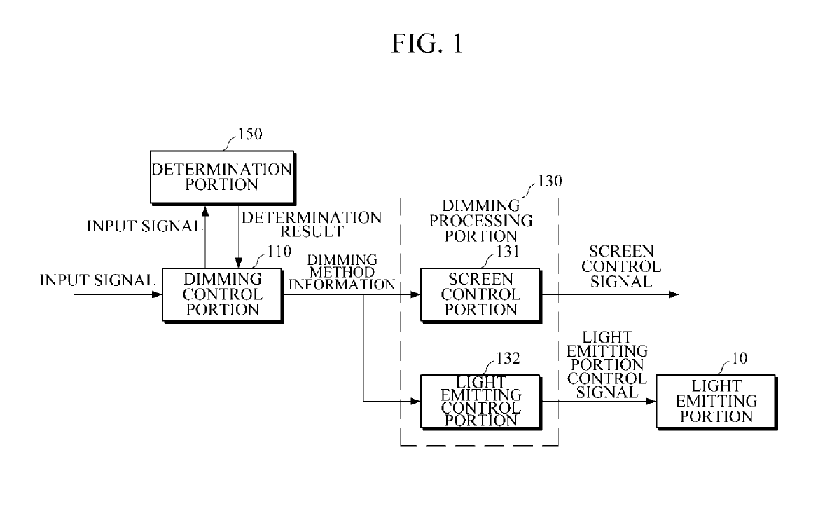

FIG. 1 is a diagram showing a user interface apparatus for a dim state according to an embodiment of the inventive concept.

FIG. 1 illustrates an example of a user interface apparatus or a suitable computing device in which one or more of exemplary embodiments may be implemented, however, various computing device or system configurations may be used. The apparatus illustrated in FIG. 1 is not intended to suggest any limitation but to show an exemplary configuration for implementing the illustrated embodiments. The apparatus may include one or more processors, memories, touch screen displays, wireless communication modules, image processing modules, image sensing modules, I/O modules, and the like. The one or more processors execute computer-executable instructions and may include an application processor. For a multi-processing environment, multiple processing units may execute program instructions of multiple applications such that a multi-tasking of processing an event while executing one or more applications is possible.

Further, the user interface apparatus may include a backlight module and/or a backlight controller to control dimming of the display screen. The backlight module and/or the backlight controller may control the intensity of the backlight capable of local dimming. With respect to the local dimming, backlight may include one or more light sources, e.g., LED arrays or other local dimming configurations, and the backlight controller may control the light sources for a sequential dimming of two or more light source groups or may control an array of light sources for a gradual and/or simultaneous dimming of the array of light sources.

Referring to FIG. 1, the user interface apparatus may include a dimming control portion 110, a determination portion 150, and a dimming processing portion 130.

The dimming control portion 110 may wait for an input signal including a touch of a display screen or a key input event while maintaining a waiting state for a set dimming wait time. If the input signal is received within the set dimming wait time, the dimming control portion 110 may reset the dimming wait time and maintain the waiting state. The dimming wait time may be a determined time period between the time when the last input is received by the user interface apparatus and the start time of the dim state. The user interface apparatus may determine whether to change the state of the display screen to a dim state based on the dimming wait time.

If the input signal is not received within the set dimming wait time, the dimming wait time expires and the dimming control portion 110 may perform a process for switching the bright and active state of a terminal to a dim state. The dimming control portion 110 may determine a dimming method if multiple dimming methods are available. As a general method currently employed in a smart phone or a tablet PC, etc., the dimming method may include a method of switching the entire screen to the dim state all at once (this dimming method may also be referred to as “instant dimming”). Further, the dimming method may include a method of dividing the screen into two or more areas, and switching the two or more areas to the dim state one-by-one until the entire screen is switched to the dim state (this dimming method may also be referred to as “sequential dimming”). Moreover, the dimming method may include a method of gradually widening a dim area around a specific location of the screen (this dimming method may also be referred to as “gradual dimming”). The dimming method may be determined by setting information and/or a user selection and the dim area may receive an input from a user or may be determined based on setting information. The input signal may include a touch input and a physical hardware key input, and various input apparatuses and methods included in a corresponding terminal, such as input through a motion recognition sensor.

The dimming control portion 110 may transmit dimming method information including a dimming switch signal for switching the screen to the dim state, based on a set dimming method, to the dimming processing portion 130. The dimming switch signal may be information about the dimming method for switching from a normal state to the dim state, and may include a range of the dim area, a display method of the dim area, and a switching method of the dim area. Further, the dimming switch signal may further include information about a method of displaying useful information on the screen for the user before or while switching the screen from the dim state to an off state. The normal state may be referred to as a bright state in which the emitted backlight turns on the entire display screen without dimming.

The dim state may be a darkened state or a less bright state in which an image may still be displayed on the screen but less bright than the normal state. Accordingly, the dimming control portion 110 may generate the dimming method information in order to adjust the brightness of the screen according to the dim area of the set dimming method, and transmit the dimming method information to the dimming processing portion 130. The dimming method information may include information about the dimming method and the dim area according to the dimming method.

In the user interface apparatus, if the screen is switched to the dim state, a touch input on the touch-based display screen may have no effect on the current display screen or an application program displayed on the display screen, and may switch the display screen from the dim state to the normal state. Further, if a local dimming is operated, a touch input on a dim area may switch the dim state to the normal state without allowing other operations except changing the dim state. If a touch input is received on a bright area while another area is in a dim state, the touch input may trigger the switch from the dim state of the other area to the normal state while operating an application or a function corresponding to the touched location of the touch input. The normal state may include a screen state in which a light emitting portion such as a backlight is fully turned on. Accordingly, the dimming control portion 110 may generate the dimming method information based on the set dimming method and transfer the dimming method information to the dimming processing portion 130. The dimming method information may include information about the dim area and the dimming method according to the set dimming method. According to the dimming method information transmitted to the dimming processing portion 130, the dimming processing portion 130 may differently display an area which is not in the dim state by a touch input with respect the dim area switched to the dim state on the screen.

If the dimming control portion 110 does not receive the input signal within the set dimming wait time, the dimming control portion 110 may perform a dimming process, e.g., the above-described process. Further, the dimming control portion 110 may switch the screen to the dim state and control the screen to wait in the dim state for the screen hold time. The screen hold time is a wait time maintained until the screen switches from the dim state to the screen off state in which the display screen is completely turned off. Further, the screen hold time may be the duration of the dim state, a determined time period between the start time of the dim state and the time when the dim state is changed to screen off state, or a determined time period between the start time of the dim state and the time when the entire display screen is changed to a dim area.

The dimming control portion 110, in the dim state, may determine an input of a physical button as an input for turning on the screen again, and switch the screen to the normal state without performing an operation corresponding to the physical button designated in the normal state. More specifically, when the screen is switched to the dim state, in response to an input on a home button or a volume control button, the screen may be switched to the normal state without performing an operation of changing a volume or switching to the home screen, etc.

If a certain input signal is received through a touch input within the screen hold time while waiting in the dim state, the determination portion 150 may determine whether the touch input is received in the dim area switched to the dim state or in a normal area (a bright area) other than the dim area. The determination portion 150 may determine an area in which the touch input is received and transmit the determination result to the dimming control portion 110.

If the determination result received from the determination portion 150 indicates that a touch input is received in a normal area, the dimming control portion 110 may switch the screen from the dim state to the normal state and perform a function corresponding to the touch input. If the determination result received from the determination portion 150 indicates that a touch input is received in the dim area, the dimming control portion 110 may switch the screen to the normal state regardless of the state of the display screen or the type of an application program running, and perform the control of the user interface apparatus so that the display screen or the application does not respond to the touch input. More specifically, a function, an icon, or other application control interface displayed in the dim area may be configured not to respond to the touch input such that the touch input received on the dim area may be inoperable except certain display state managing operations, e.g., the operation of changing the dim state to the normal state, an operation for changing the remaining time of the dim state, and the like.

The dimming control portion 110 may transmit dimming method information including the normal switch signal for switching the screen from the dim state to the normal state to the dimming processing portion 130, and the dimming processing portion 130 controls the display screen and the backlight according to the received information.

If an input signal is not received from a user while waiting in the dim state during the screen hold time, the dimming control portion 110 may turn off the screen and switch the screen to the screen off state. The process of switching from the dim state to the screen off state may use the same method applied in current smart phones or tablet PCs, etc. The screen off state may be an idle state in which backlight is turned off and executed applications are running in the background.

Based on the dimming switch signal or the normal switch signal included in the dimming method information received from the dimming control portion 110, the dimming processing portion 130 may assign or determine the dim area on the screen, or switch the screen from the dim state to the normal state.

The dimming processing portion 130 may include a screen control portion 131 and a light emitting control portion 132.

Based on the dimming method information received from the dimming control portion 110, the light emitting control portion 132 may generate a light emitting portion control signal and transmit the light emitting portion control signal to a light emitting portion 10. The light emitting control portion 132 may recognize the dimming method and the dim area according to the dimming method information included in the dimming switch signal. Further, based on the dimming method and the dim area, the light emitting control portion 132 may transmit the light emitting portion control signal to the light emitting portion 10 in order to switch a portion of the screen or the full screen to the dim state.

As described above, the dimming method may include a method of switching the entire screen to the dim state all at once. Further, the dimming method may include a method of dividing the screen into two or more areas, and switching the two or more areas to the dim state one-by-one until the entire screen is switched to the dim state. Further, the dimming method may include a method of switching a specific location of the screen to the dim state and gradually widening the dim area around the specific location of the screen. Moreover, the dimming method may include a method of switching the screen to the dim state gradually and continuously.

Based on the dimming method included in the dimming method information, the light emitting control portion 132 may generate the light emitting portion control signal for switching the screen to the dim state. The light emitting portion 10 that receives the light emitting portion control signal from the light emitting control portion 132 may switch the screen to the dim state according to the dimming method by controlling a light emitting device, a light emitting apparatus, or backlight based on the light emitting portion control signal.

In the light emitting portion 10, a method of switching the screen to the dim state may differ according to types and features of the screen and the light emitting portion 10. In the case of a display using cold cathode fluorescent lamps (CCFLs) or light emitting diodes (LEDs) as the backlight, the screen may be switched to the dim state by partly or entirely controlling a corresponding backlight. In the case of a display using organic light emitting diodes (OLEDs), in which screen brightness is controlled through a self-emission effect without an additional light emitting apparatus such as a backlight, the screen may be switched to the dim state by controlling the self-emission of the OLEDs. A method of controlling switching of the screen to the dim state is not limited to methods that use additional configuration elements such as the above backlight or the self-emission apparatus such as the OLED display, but other methods of switching the screen to the dim state may also be utilized.

Moreover, if the light emitting control portion 132 receives the dimming method information including the normal switch signal for switching from the dim state to the normal state from the dimming control portion 110, based on the dimming method information, the light emitting control portion 132 may transmit the light emitting portion control signal including information for switching the screen from the dim state to the normal state to the light emitting portion 10. The light emitting portion 10 may switch the screen from the dim state to the normal state based on the light emitting portion control signal.

The screen control portion 131 may generate and transmit a screen control signal for controlling the screen, based on the range and/or disposition of the dim area, the display method of the dim area, and the switching method of the dim area included in the dimming method information. The screen control signal may further include a method of displaying additional information included in the dimming method information on the screen. The additional information may include count information indicating the remaining time of the screen hold time in the dim state.

The screen control signal of the screen control portion 131 may distinguish the dim area switched to the dim state from a normal area, which is not the dim area, based on the dimming method information. If the dim area and the normal area are touched, the screen control portion 131 may recognize the touch inputs as different from each other. A touch input on a dim area may be recognized as a touch input on a dim area and processed according to a touch input processing scheme for a dim area, and a touch input on a normal area (bright area) may be recognized as a touch input on a normal area and processed according to a touch input processing scheme for a normal area. If the normal area is touched, the screen control portion 131 may switch the screen from the dim state to the normal state and respond to the touch input for executing a function or an interface of the content or application program, which is displayed on the screen corresponding to the touch input. More specifically, if the screen is touched in the normal area, the screen may respond to the touch input regardless of the dim state or the normal state. The dimming control portion 110 may perform control operations to include information for switching from the dim state to the normal state in the dimming method information and to transmit the information to the dimming processing portion 130.

If the dim area, which is not the normal area, is touched, the screen is switched from the dim state to the normal state without performing other operations for an application in response to the touch input, and the screen control portion 131 may recognize the touch input as a screen state change input regardless of the content or the application program, which is currently displayed on the screen. More specifically, if the dim area is touched, a corresponding touch input may be recognized as an input for switching the screen to the normal state, and the application program currently running or the screen may not respond to the touch input.

The screen control portion 131 may further display an additional application program having a screen, which is transparent or semitransparent in the dim area, and may distinguish the dim area from the normal area in processing of an operation or a touch input. More specifically, although the same screen in a dim state may be provided to the user through the additional application program having the screen which is transparent or semitransparent, if the user touches the dim area, the touch input may not be an input for the screen that the user is looking at but for the additional application program. The additional application program may recognize the touch input as an input for switching the screen state from the dim state to the normal state.

The method of distinguishing the dim area from the normal area through the additional application program is one embodiment of a method for preventing the touch input with respect to the dim area from having an effect on the displayed application program or the displayed screen. Various alternative embodiments may be applicable to prevent an unintended execution of an application or content in response to a touch input received on a dim area.

The screen control portion 131 may perform control operations to display additional information on the screen in the dim state. It may be difficult for the user to estimate the screen hold time to maintain the dim state before switching from the dim state to the screen off state. Further, the dim area may not be easily recognized by the user. Accordingly, the screen control portion 131 may display the remaining screen hold time on the screen if the screen is switched to the dim state.

The screen control portion 131 may display the remaining screen hold time in the form of an analog or digital timer, and the remaining screen hold time may be displayed in either one of the dim area and the normal area.

The screen control portion 131 may display a specific image or text, or an image similar to a screen saver of a PC, on the screen, in order to indicate the screen hold time to the user.

A method of indicating the screen hold time to the user may include a method of directly displaying the screen hold time on the screen through the screen control portion 131, as well as a method of switching the screen to the dim state, in the light emitting control portion 132. For example, if the screen is switched to the dim state through a method of dividing the screen into two or more areas, and switching the two or more areas to the dim state one-by-one, or a method of switching a specific location of the screen to the dim state and gradually widening the dim area around the specific location, the user may be informed of the remaining screen hold time by switching the screen to the screen off state according to the methods.

Further, if the screen is switched to the dim state through a method of gradually and continuously dimming the screen, the user may be informed of the remaining screen hold time by switching the screen to the screen off state and the expiration of the remaining hold time when the screen is completely switched to the dim state and subsequent turn off of the screen.

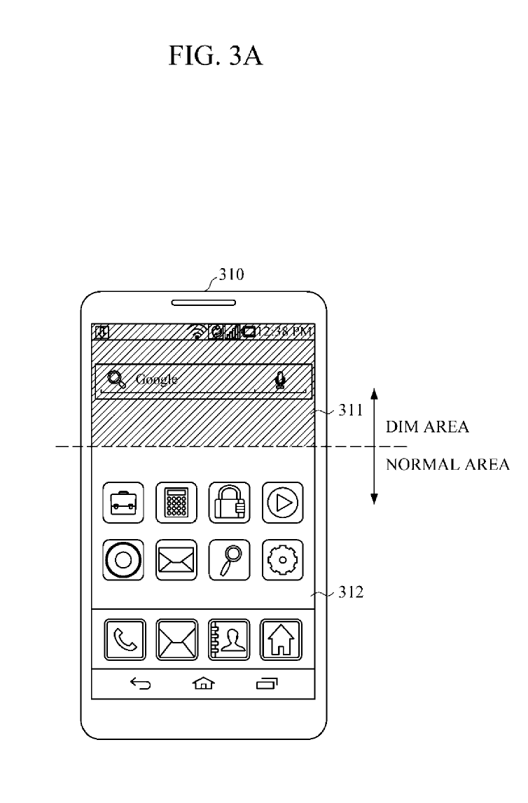

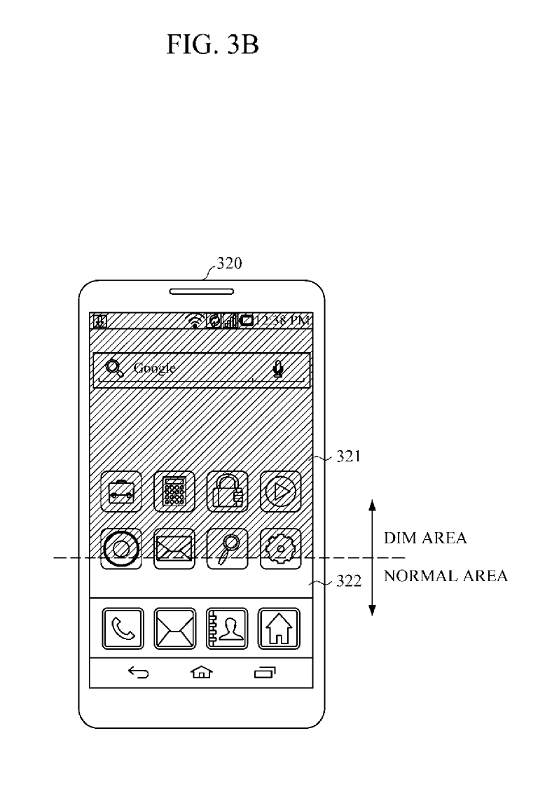

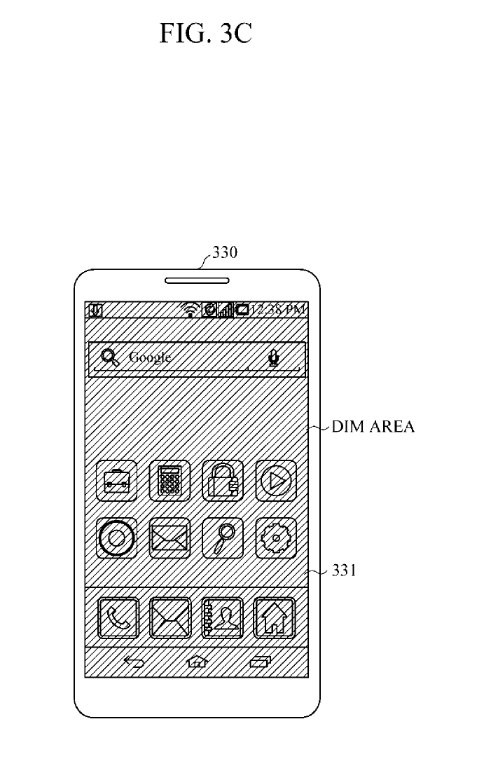

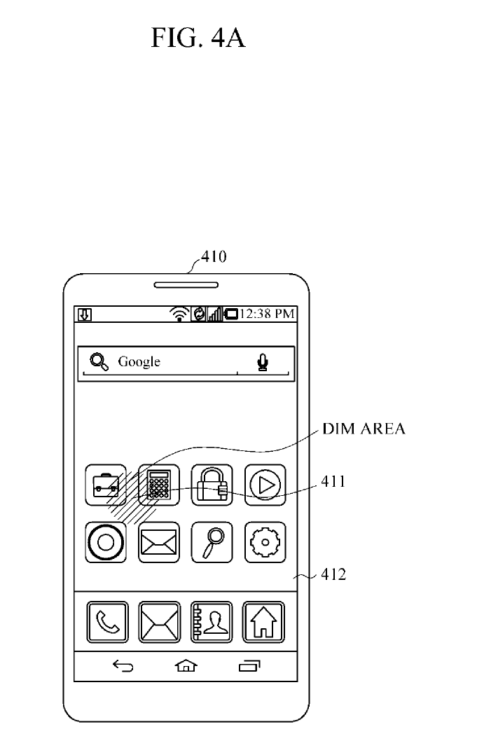

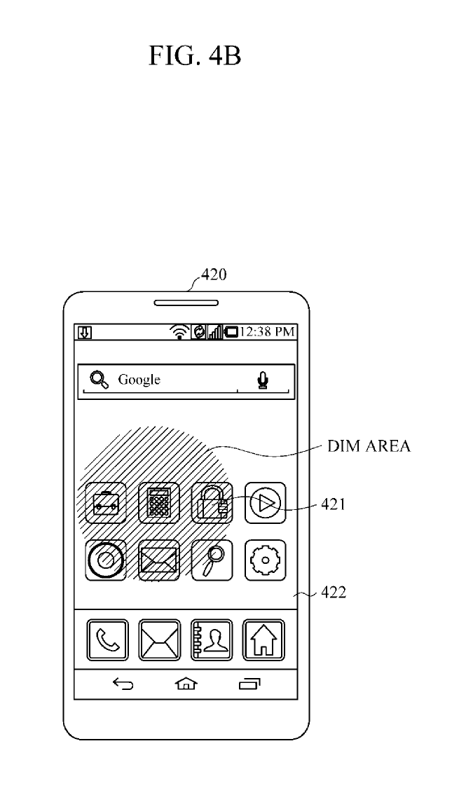

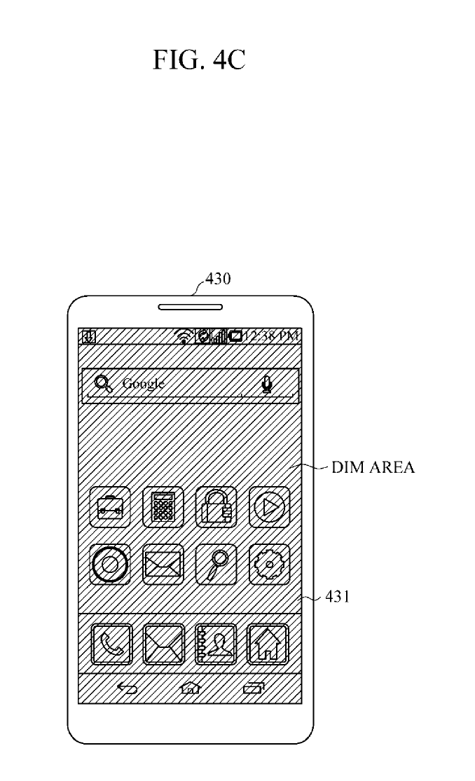

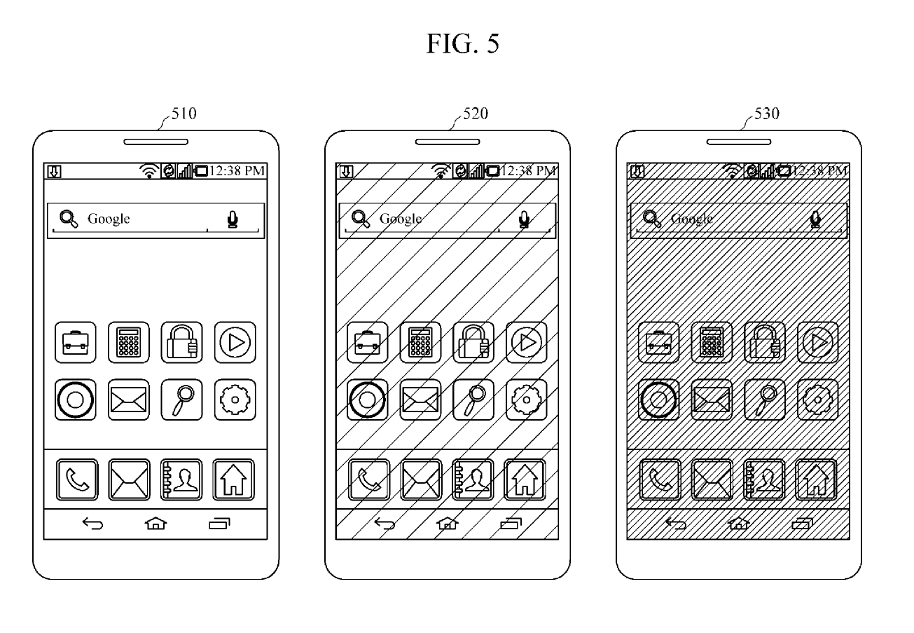

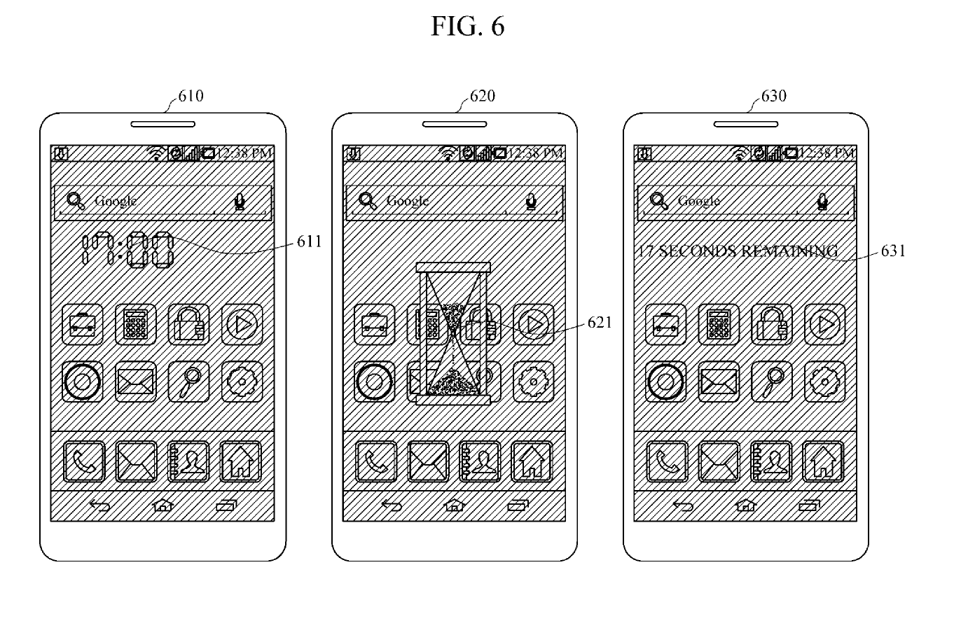

A method for switching the screen to the dim state and displaying the screen hold time in the dimming processing portion 130 will be explained below with reference to FIG. 3, FIG. 4, FIG. 5 and FIG. 6.

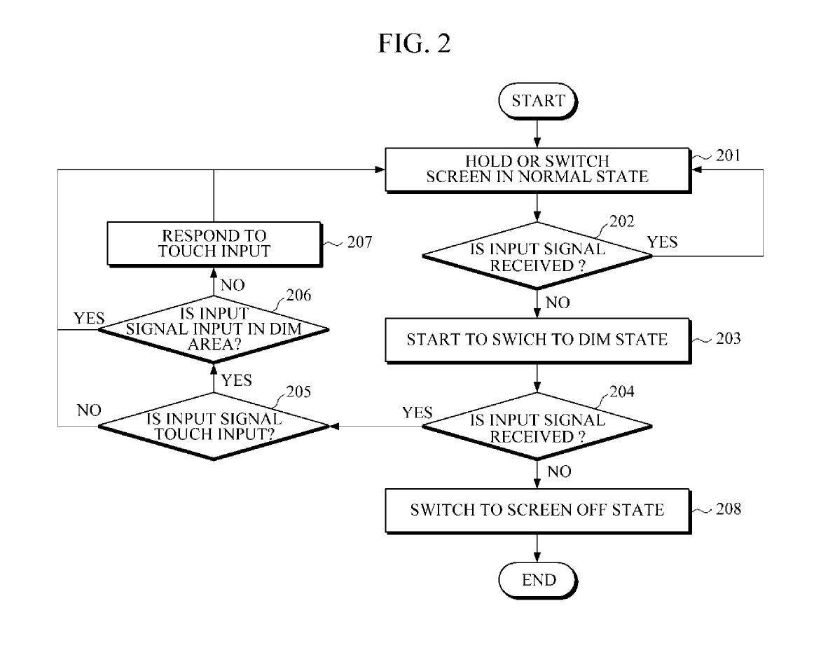

FIG. 2 is a flowchart showing a method of providing a user interface according to an exemplary embodiment of the present invention.

Referring to FIG. 2, in the method of providing the user interface, the screen may be switched to or maintained in the normal state (operation 201). The normal state is a state in which a backlight or an OLED is fully emitted and the screen is fully turned on without a dim area. In the normal state, it may be determined whether a touch input or a physical input is received during the dimming wait time (operation 202). While maintaining the normal state in which the screen is fully turned on, the screen may wait for the dimming wait time before entering the dim state. The dimming wait time is a wait time before switching the screen from the normal state to the dim state. If no input is received within the set dimming wait time, an operation of dimming the screen may be performed. If a certain input including a touch input or a physical input is received within the dimming wait time, the screen may be maintained in the normal state (operation 201) and the counter of the dimming wait time may restart.

If the certain input is not received during the dimming wait time, the screen may start to switch from the normal state to the dim state (operation 203). While waiting in the normal state, if the certain input including the touch input or the physical input is not received within the dimming wait time, the normal state may be terminated and the screen may be switched to the dim state. The dimming method for switching the screen from the normal state to the dim state may include a method of switching the entire screen to the dim state all at once. Further, the dimming method may include a method of dividing the screen into two or more areas, and switching the two or more areas to the dim state one-by-one until the entire screen is switched to the dim state. Further, the dimming method may include a method of switching a specific location of the screen to the dim state and gradually widening the dim area around the specific location of the screen.

When switching to the dim state, the screen may be divided into the dim area, which is switched to the dim state, and the normal area. A method of dividing the screen into the dim area and the normal area may include displaying an additional application program having a screen which is transparent or semitransparent in the dim area, and dividing into the dim area and the normal area, although the same screen as a general dim state is provided to the user through the additional application program having the screen which is transparent or semitransparent, a touch input on the dim area may not control the application or content displayed in the dim area of the screen but may be an input to the additional application program to change the dim state to the normal state.

Further, additional information may be displayed on the screen while switching to dim state or in the dim state. It may be difficult for the user to predict the remaining screen hold time before switching from the dim state to the screen off state. Accordingly, the remaining screen hold time may be displayed on the screen while the screen is switched or in the dim state. The remaining screen hold time may be displayed in the form of an analog or digital timer in at least one of the dim area and the normal area. A specific image or text, etc. may be displayed on the screen in order to transmit the screen hold time to the user.

In the dim state, it may be determined whether a touch input or a physical input is received during the screen hold time (operation 204). In the process of switching to the dim state, or in the dim state, the screen may wait for the expiration of the screen hold time. The screen hold time is a wait time to switch from the dim state to the screen off state in which the screen is completely turned off. The wait time may be calculated after completing switching of the screen to the dim state, and may include a time estimated from a time of starting the switch to the dim state to a time of completing the switch to the dim state. If the screen is sequentially or gradually switched to the dim state, an estimated time for switching to the dim state may be set to be equal to the screen hold time. Accordingly, the full screen may be switched to the dim state and, at the same time, to the screen off state. In this case, the remaining time for switching to the screen off state through the interface screen which is sequentially or gradually switched to the dim state may be indicated as visual effects of the dimming changes.

If the touch input or the physical input is not received during the screen hold time, the screen may be switched to the screen off state (operation 208). While waiting in the dim state during the screen hold time, if a certain input signal including the touch input or the physical input is not received, the screen may be completely turned off and switched to the screen off state. The screen off state is a state in which the screen, including the backlight as well as the display, such as the LCD or the OLED, is completely turned off. A process of switching the screen from the dim state to the screen off state may use the same method as the method used in current smart phones, tablet PCs, and so on. This state may be a screen state in a sleep mode of the current smart phone, tablet PC, and so on.

If the certain input is received during the screen hold time, a type of the certain input may be determined (operation 205). If the certain input including the touch input or the physical input is received during the screen hold time while waiting in the dim state, it may be determined whether the certain input is the touch input or some other input including the physical input.

If the certain input is not the touch input, the screen may be switched to the normal state, regardless of the type of the certain input (operation 201). For example, if a physical key is input, the terminal may display a response to the key input. However, in the case of switching the screen to the dim state, regardless of an original function of the key, the function of the key may not be processed and the screen may be switched to the normal state. For example, when the screen is in the dim state, if the volume control button is pushed, the screen may be fully turned on and, simultaneously, a volume may be controlled. However, when the screen is in the dim state, if the volume control button is pushed, the screen may be fully turned on and simultaneously switched to the normal state. According to the latter scheme, if the user pushes the physical button for switching the screen from the dim state to the normal state, an unintended operation can be avoided.

If the certain input signal is a touch input, it may be determined whether the touch input is in the dim area (operation 206). A method of dividing the screen into the dim area and the normal area may include displaying an additional application program having the screen, which is transparent or semitransparent in the dim area, and dividing the screen into the dim area and the normal area. Although the same screen in a general dim state is provided to the user through the additional application program having the screen, which is transparent or semitransparent, a touch input in the dim area may be an input not to the screen that the user is looking at but to the additional application program. The additional application program may recognize the touch input as an input for switching from the dim state to the normal state. The method of dividing the screen into the dim area and the normal area through the additional application program is an example of a method for preventing the touch input associated with the dim area from having an effect on the application program or the screen currently running. However, other embodiments may also be applied to freeze the execution of an application program in response to a touch input received on a dim area.

If the touch input is input in the normal area, there may be a response to the touch input (operation 207), and the screen may also switch to the normal state (operation 201). If the normal area is touched, the screen may switch from the dim state to the normal state and, at the same time, may normally respond to the interface of the content and the application program, which is currently displayed on the screen. More specifically, if the normal state area is touched, the screen may respond to the corresponding touch input regardless of the dim state or the normal state and an application may perform an operation or be executed in response to the touch input. This operation may be similar to a responsive operation in response to a touch input in the dim state, which is used in a terminal including a touch interface used in current smart phones or tablet PCs.

However, if the touch input is input in the dim area, the screen may be switched to the normal state (operation 201). If the dim area is touched, the screen is switched from the dim state to the normal state without executing or performing an application corresponding to the location of the touch input, and the screen control portion 131 may process the touch input without associating with the content and/or the application program which is currently displayed on the screen. If the dim area is touched, the corresponding touch input may be recognized as an input for switching the screen to the normal state, and the application program or the screen currently running may not respond to the touch input.

Further, if a specific touch input is input in the dim area, an additional function may be provided with respect to the specific touch input. For example, with respect to an input of dragging up and down in the dim area, the screen hold time may be increased by recognizing the input as instructions for not returning the screen from the dim state to the normal state, but holding in the dim state and increasing the screen hold time. Various touch inputs including continuous touch inputs, or multiple touch inputs, and so on may be utilized for controlling the screen hold time, as well as the input dragging up and down in the dim area. Further, a touch input pattern or gesture may be designated for an operation associated with the dim area if the touch input pattern or gesture is received in the dim area.

The user interface apparatus for the dim state, when the screen is switched from the normal state to the dim state, may use a method of switching all at once, and also may use a method of generating a dim area in a portion of the screen and gradually expanding the dim area such that the full screen is changed into a dim area. A method of gradually expanding the dim area may be a method of dividing the screen into two or more areas, sequentially switching each of the divided areas to the dim state until the full screen is changed into a dim area. Examples of the methods will be explained below with reference to FIG. 3 and FIG. 4.

FIG. 3A, FIG. 3B, and FIG. 3C are diagrams showing a sequential expansion of a dim area of a user interface for a dim state according to an exemplary embodiment of the present invention. FIG. 3A is a diagram of a screen in which ⅓ of the full screen is switched to the dim state, FIG. 3B is a diagram of the screen in which ⅔ of the full screen is switched to the dim state, and FIG. 3C is a diagram of the screen in which the full screen is switched to the dim state.

Referring to FIG. 3A, FIG. 3B, and FIG. 3C, a sequential dim area expansion of the user interface for the dim state includes dividing the full screen into three areas and sequentially switching each of the three areas to the dim state. The full screen may be divided into three areas and one among the three areas may be switched to the dim state.

Referring to FIG. 3A, a screen 310 in which ⅓ of the full screen is switched to the dim state may include a first dim area 311 occupying ⅓ of the full screen, and a first normal area 312 occupying ⅔ of the full screen. In this case, if the first dim area 311 is touched, the screen 310 may be switched to the normal state without affecting the displayed content or the application program currently running, and the screen or the application currently running may not respond to the touch input. For example, the Google® Tool bar displayed in the first dim area 311 may not respond to a touch input on the tool bar when the first dim area 311 is a dim area. If the first normal area 312 is touched, the screen 310 may be switched to the normal state, and the screen or the application currently running may respond to the touch input. For example, if an application icon displayed in the first normal area 312 is touched, the application associated with the touched icon may be executed and the first dim area 311 may be changed to a normal area.

Referring the FIG. 3B, ⅓ of the full screen may be further switched to a dim area. The screen 320 in which ⅔ of the full screen is switched to the dim state may include a second dim area 321 occupying ⅔ of the whole screen area, and a second normal area 322 occupying ⅓ of the whole screen area. In this case, if the second dim area 321 is touched, the screen 310 may be switched to the normal state without affecting the displayed content or the application program displayed in the second dim area 321, and the screen or the application currently running may not respond to the corresponding touch input. If the second normal area 322 is touched, the screen 310 may be switched to the normal state, and the screen or the application currently running may respond to the corresponding touch input.

Referring to FIG. 3C, ⅓ of the full screen may be further switched to the dim area, and thus, the full screen may be switched to the dim state. The screen 330 in which the full screen is switched to the dim state may be a state of completion of switching to the dim state of the full screen. In this case, since the full screen is switched to the dim area 331, if the screen is touched, the screen may be switched to the normal state without affecting displayed content or the application program currently running, and the screen or the application currently running may not respond to the corresponding touch input.

When the screen is switched from the normal state to the dim state, it may use a method of switching the entire screen to the dim state all at once. Further, it may use a method of dividing the full screen into two or more areas, and sequentially switching them one-by-one to the dim state. An interface screen which is sequentially switched to the dim state may provide a visualization of the process of switching to the dim state to the user, and the user may recognize the change of the dim area and respond to the operation of switching to the dim state. Time duration to switch one area to the dim state may be predetermined, or the time duration may be determined based on the dimming wait time and the screen hold time.

In FIGS. 3A, 3B, and 3C, the number of screen divisions may be set based on the dimming wait time or the screen hold time, which may be set by the user. For example, if the dimming wait time or the screen hold time is set to three seconds, the full screen may be divided into three areas, based on the dimming wait time or the screen hold time, and the three areas may be switched to a dim area one-by-one (change one area per second). Thus, switching the full screen to the dim state takes the predetermined three seconds. If the time set by the user is ‘n’ seconds, the screen may be divided into ‘n’ areas, switching the full screen to the dim state may occur during the predetermined ‘n’ seconds by sequentially switching the ‘n’ areas to the dim areas one-by-one. Through the interface of sequentially changing the dim areas, the user may directly recognize a time taken and a time remaining for switching the full screen to the dim state through visual effects. The number of areas into which the screen is divided is not limited as illustrated above, but the number of areas and the dimming holding time may be set differently. For example, if the dimming holding time is set to thirty seconds and the screen is set to be divided into three areas, the operation of switching the full screen to the dim state may be completed after thirty seconds, by sequentially switching the three areas to the dim state at every ten seconds.

In FIGS. 3A, 3B, and 3C, the screen is divided into three areas horizontally and three areas of the screen are sequentially switched to the dim state, but the present invention is not limited as such. The screen may be divided horizontally, vertically, diagonally, or in any form including circles, polygons, such as squares and triangles. Further, the number of screen divisions and the set time may not be limited, and various forms and various numbers may be applicable.

FIG. 4A, FIG. 4B, and FIG. 4C are diagrams showing a gradual expansion of a dim area of a user interface for a dim state according to an exemplary embodiment of the present invention. FIG. 4A is a diagram showing a screen which has been switched to the dim state locally. FIG. 4B is a diagram showing a screen which has been switched to the dim state globally. FIG. 4C is a diagram of a screen whose entire area has been switched to a dim state.

Referring to FIGS. 4A, 4B, and 4C, a gradual dim area expansion of the user interface apparatus may display a dim area by switching a certain point on the screen to the dim state and gradually or sequentially expanding the corresponding dim area, and then switching from a normal state to the dim state.

Referring to FIG. 4A, an operation of switching from the normal state to the dim state at a certain point or location on the screen may be initiated if no input is received during a certain period of time. The screen 410 may be switched to the dim state locally, and the local dim area may be expanded to a first dim area 411. In this case, if the first dim area 411 is touched, the screen may be switched to the normal state without affecting displayed content or an application program associated with the first dim area 411, and the screen or the application program currently running may not respond to the corresponding touch input received in the first dim area 411. If a first normal area 412 is touched, the entire screen may be switched to the normal state, and the screen or the application program currently running may respond to the corresponding touch input.

Referring to FIG. 4B, the dim area switched to the dim state locally may be gradually expanded over time, and a screen 420 may be switched to the dim state globally. If a predetermined time elapses, the dim area may be expanded from a first dim area 411, which is the local area, to a second dim area 421. In this case, if the second dim area 421 is touched, the screen may be switched to the normal state without affecting the displayed content or an application program currently running, and the content on the screen or the application program may not respond to the corresponding touch input. If a second normal area 422 is touched, the screen may be switched to the normal state, and the screen or the application program may respond to the corresponding touch input.

Referring to FIG. 4C, a dim area gradually expanded starting from the local area may be expanded until the entire screen of a screen 430 is switched to the dim state. In this case, since the full screen may be the dim area 431, if the screen is touched, the screen may be switched to the normal state without affecting the displayed content on the screen or the application program currently running, and the screen or the application may not respond to the corresponding touch input.

When the screen is switched from the normal state to the dim state, the entire screen may be switched to the dim state all at once. Further, the user interface apparatus may use a method of gradually expanding the dim area starting from the local area and expanding the dim state to the full screen. An interface screen, which may be gradually switched to the dim state starting from the local area, may provide a visualization of the process of switching to the dim state to the user, and then the user may effectively respond to the operation of switching to the dim state. Time duration to switch the entire screen to the dim state by gradually expanding the dim area starting from the local area may be predetermined, or the time duration may be determined based on the dimming wait time and/or the screen hold time.

In FIGS. 4A, 4B, and 4C, the dim area is expanded from the central portion of the screen in a circular form, for example. A starting point for switching to the dim state may be set within the screen, such as at the edge or the central portion of the screen. Further, the form in which the dim area is expanded may be different shapes besides a circular form, and the dim area may be expanded from the top of the screen, the bottom of the screen, the right side of the screen, or the left side of the screen, vertically or horizontally.

FIG. 5 is a diagram showing a gradual expansion of a dim area of a user interface for a dim state according to an exemplary embodiment of the present invention.

In the above-described FIGS. 4A, 4B, and 4C, a local area of the screen may be switched to the dim state, and the full screen may be switched to the dim state by gradually expanding the dim area. However, in FIG. 5, the entire screen may be gradually switched to a dim state 530 by gradually changing the brightness of the backlight. More specifically, the entire screen is switched from the normal state 510 to a gradual darkened state 520 (“less bright state”) by gradually lowering the degree of brightness of the light emitting portion 10 until the screen is completely changed to the dim state 530. In this case, with respect to a touch input in the dim state 530, the screen may be switched to the normal state without affecting the content on the screen or the application program currently running, and the screen or the application currently running may not respond to the touch input.

If the screen is in the less bright state 520, a response with respect to the touch input may vary according to a setting. The less bright state 520 may be determined as the normal state 510, and the screen may be switched to the normal state and set to respond to the touch input. Further, the screen may be switched to the normal state without affecting the content displayed on the screen or the application if the touch input is received in the less bright state 520 or the dim state 530, and the content displayed on the screen or the application currently running may not respond to the corresponding touch input.

As described above, a process of switching from the normal state 510 to the less bright state 520, and from the less bright state 520 to the dim state 530 may be performed by gradually controlling the intensity of the backlight. Further, the screen may be switched from the normal state 510 to the dim state 530 discretely by dividing degree of brightness into a predetermined number of levels, e.g., a first brightness level for the normal state 510, a second brightness level for the less bright state 520, and a third brightness level for the dim state 530.

FIG. 6 is a diagram showing an additional information interface of a user interface for a dim state according to an exemplary embodiment of the present invention.

Referring to FIG. 6, the additional information interface of the user interface may include an additional information interface using a number 610, an additional information interface using an image 620, and an additional information interface using text 630. The user can recognize, through the additional information interfaces, information of the remaining screen hold time, e.g., when the screen will switch from the dim state to the screen off state.

The additional information interface using the number 610, when the screen is switched to the dim state, may display the remaining screen hold time by displaying the number 611 at a certain location of the dimming screen.

The additional information interface using the image 620, when the screen is switched to the dim state, may display the remaining screen hold time by displaying the image 620 at a certain location of the screen. In FIG. 6, the screen hold time may be displayed using an hourglass image, for example. Any picture or image that can represent the remaining time, such as an icon displaying the remaining time gauge or an analog clock (timer), may be included.

The additional information interface using the text 630, when the screen is switched to the dim state, may display the remaining screen hold time by displaying the text at a certain location of the dimming screen.

FIG. 6 shows the additional information interface displaying the remaining screen hold time using the number, image, or text, to the user. However, the additional information interface may not be limited to the number, image, or text. In the dim state, the remaining screen hold time may be output by a direct sound or a predetermined alarm sound to the user. Further, if a vibrator is embedded in the terminal, the screen hold time may be reported to the user by controlling the degree of vibration through the vibrator.

Further, as described above, in addition to displaying the additional information interface on the screen in the dim state, a process of switching from the normal state to the dim state may also be displayed on the screen. More specifically, by displaying the additional information interface on the screen and showing a process of gradually or sequentially switching to the dim state, the user may predict the screen switching time.

According to aspects of the present invention, an unintended screen change or an application execution may be avoided in response to a touch input in the dim state, and the inconvenience of the user having to input a specific input in order to convert the dim state to the normal state can be reduced. Further, the user may recognize the remaining time by displaying remaining screen hold time in the dim state to the user.

If the user interface apparatus is in a dim state, at least a portion of a display screen of the user interface apparatus may be changed to a frozen state in which a touch input on a displayed item may be incapable of executing a function of an application associated with the item. Further, the frozen state may correspond to a dim area. More specifically, if a first portion of a display screen is changed to a dim area by dimming backlight for the first portion, the display screen corresponding to the first portion may be changed to the frozen state. If a touch input is received on an application icon displayed in the first portion, the application icon does not respond to the touch input and the application icon is not executed according to the touch input because the first portion is in the frozen state. However, a touch input on an item displayed in a second portion of the display screen may execute a function associated with the item displayed in the second portion when the second portion does not correspond to a dim area and is not in the frozen state.

Further, the color of a portion of a display screen may be changed to indicate that the portion of the display screen is in a frozen state. For example, a portion of the display screen may be changed to gray or black-and-white monochrome color forms to indicate the corresponding portion is in the frozen state and/or a dim area. The expansion of the color indicating the frozen state and/or the dim area may provide another indication of the remaining time of the screen hold time and provide an indication whether a touch input on a displayed item is capable of executing an operation, a function, or an application associated with the displayed item. Further, a touch input on a dim area may be associated with one or more dedicated functions or operations in association with the dim area. For example, a user may want to change the screen hold time, the dimming wait time, or other screen time outs without entering screen display setting menu. Also, brightness of the screen, touch key light duration may be controlled based on a touch input received in a dim area. These setting changes may be performed directly based on a gesture or a type of a touch input received in a dim area, or a setting change screen may be displayed in response to a certain touch input in the dim area.

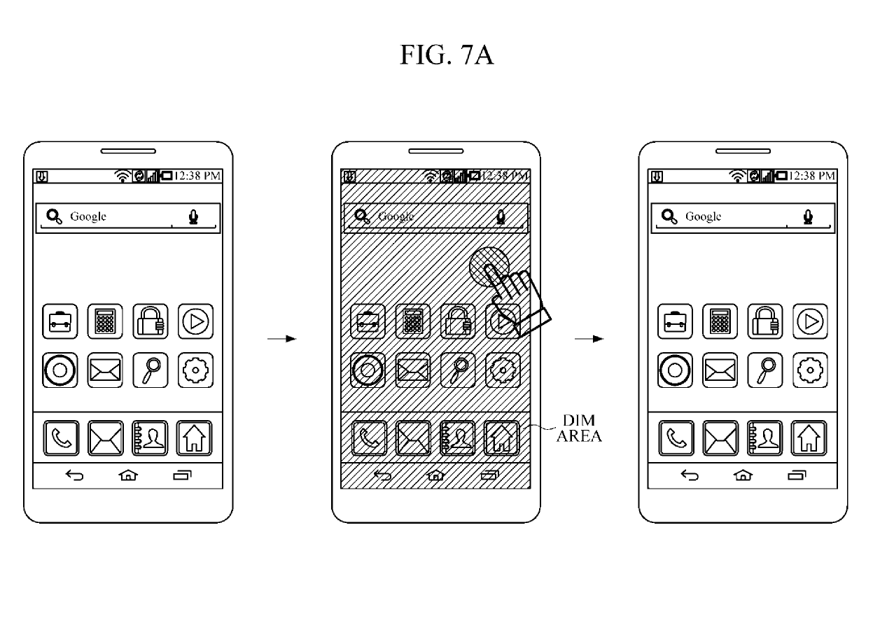

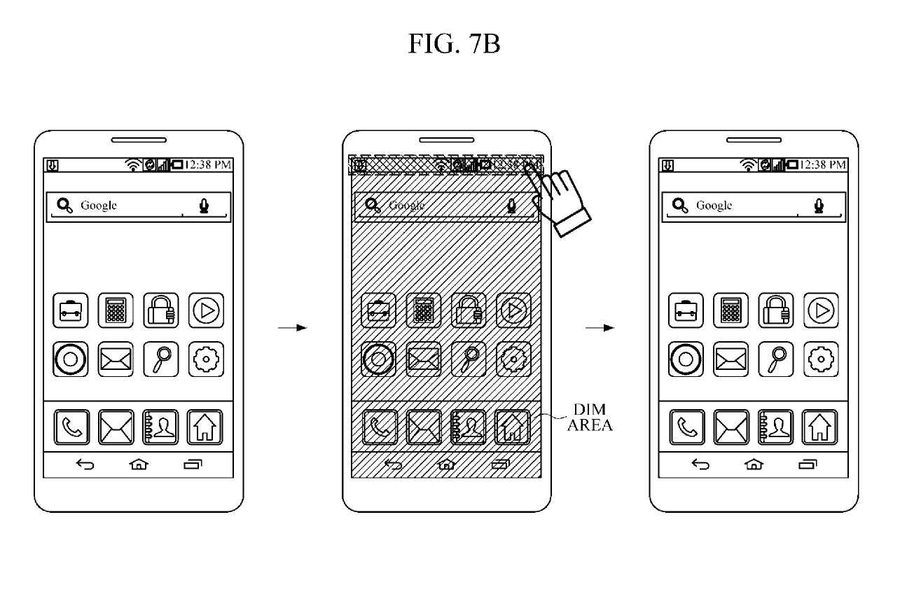

FIG. 7A and FIG. 7B are diagrams showing a state recovery icon displayed during a dim state according to an exemplary embodiment of the present invention.

As shown in FIG. 7A, a user interface apparatus 700 may not receive an input from a user for a predetermined period and a display 710 of the user interface apparatus 700 may be dimmed and the state of the user interface apparatus 700 changes into a dim state. If the user interface apparatus 700 is in a dim state, a state recovery icon 711 (or a state conversion icon 711) may be displayed in an area of the display 710. In the dim state, a user may touch the display 710 and the touch may execute an application when the user touches an area of a displayed application icon other than the area in which the state recovery icon 711 is displayed. According to aspects of the invention, in the dim state, a user may touch the display 710 and the touch may not execute an application when the user touches an area of a displayed application icon other than the area in which the state recovery icon 711 is displayed. In this configuration, a touch corresponding to the state recovery icon 711 is active while other touches on other areas are not responsive during a dim state. If the user touches the state recovery icon 711, the user interface apparatus 700 may change its state from the dim state to an active state (or a normal state). Further, as shown in FIG. 7B, a user may touch a predetermined area 712 (or a state conversion area 712) of the display 710 to change the dim state of the user interface apparatus 700 into the active state instead of providing the configuration of displaying the state recovery icon 711. The predetermined area 712 may be indicated by changing a color, shading fill, border, etc., of the predetermined area 712 from other areas. The state recovery icon 711 or the predetermined area 712 may be reconfigured or relocated by a user setting. Further, a state conversion icon 711 may include a first state conversion icon to change the dim state into a first state and a second state conversion icon to change the dim state into a second state. The state conversion area 712 may include a first area to change the dim state into a first state and a second area to change the dim state into a second state.

The methods and processes according to exemplary embodiments of the present invention can be implemented as computer-readable codes in a computer readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. In addition, the computer-readable recording medium may be distributed among computer systems over a network, in which computer-readable code may be stored and executed in a distributed manner. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. It will be apparent to those skilled in the art that various modifications and amount of change can be made in the present invention without departing from the spirit or scope of the invention. Thus, it is intended that the present invention cover the modifications and amount of changes of this invention provided they come within the scope of the appended claims and their equivalents.

What is claimed is:

1. A method for controlling a state of a display apparatus, the method comprising:
controlling a light emitting portion to change a first portion of a display screen of the display apparatus to a first dim area;
after changing the first portion to the first dim area, controlling the light emitting portion to change a second portion of the display screen of the display apparatus to a second dim area, the change of the second portion to the second dim area being associated with a termination time of a dim state; and
controlling the light emitting portion to change the state of the display apparatus from the dim state to another state according to the termination time of the dim state.

2. The method of claim 1, further comprising:
if the first portion is changed to the first dim area, changing the first dim area to a frozen state such that a touch input on an item displayed in the first dim area is incapable of executing a function associated with the item.

3. The method of claim 2, wherein if the touch input is received when the first dim area is in the frozen state, at least a part of the first portion is changed from the first dim area to a brighter area in response to the touch input, the brighter area being at least brighter than the first dim area.

4. The method of claim 2, wherein if the touch input is received when the first dim area is in the frozen state, the termination time of the dim state is controlled according to a direction of the touch input.

5. The method of claim 1, wherein the dim state comprises at least one dim area in the display screen, and
when a state of the first portion corresponds to the first dim area and a state of the second portion does not correspond to the second dim area, the first portion is in a frozen state and the second portion is not in a frozen state.

6. The method of claim 1, further comprising:
displaying an indicator that indicates time information associated with the termination time of the dim state during the dim state.

7. The method of claim 6, wherein the indicator comprises an image displayed in at least one dim area.

8. The method of claim 1, further comprising determining a time period between the change of the first portion to the first dim area and the change of the second portion to the second dim area based on duration of the dim state.

9. A display apparatus to control a state of a display screen, comprising:
a light emitting portion to emit a backlight, the light emitting portion being capable of generating a partial dim area on the display screen of the display apparatus; and
a processor configured to control the light emitting portion to change a first portion of the display screen of the display apparatus to a first dim area,
wherein, after the first portion is changed to the first dim area, the processor controls the light emitting portion to change a second portion of the display screen of the display apparatus to a second dim area, the change of the second portion to the second dim area being associated with a termination time of a dim state; and
wherein the processor controls the light emitting portion to change the state of the display ii apparatus from the dim state to another state according to the termination time of the dim state.

10. The display apparatus of claim 9, wherein, if the first portion is changed to the first dim area, the processor changes the first dim area to a frozen state such that a touch input on an item displayed in the first dim area is incapable of executing a function associated with the item.

11. The display apparatus of claim 10, wherein if the touch input is received when the first dim area is in the frozen state, at least a part of the first portion is changed from the first dim area to a brighter area in response to the touch input, the brighter area being at least brighter than the first dim area.

12. The display apparatus of claim 10, wherein if the touch input is received when the first dim area is in the frozen state, the termination time of the dim state is controlled according to a direction of the touch input.

13. The display apparatus of claim 9, wherein the dim state comprises at least one dim area in the display screen, and
when a state of the first portion corresponds to the first dim area and a state of the second portion does not correspond to the second dim area, the first portion is in a frozen state and the second portion is not in a frozen state.

14. The display apparatus of claim 9, wherein the display screen displays an indicator that indicates time information associated with the termination time of the dim state during the dim state.

15. The display apparatus of claim 14, wherein the indicator comprises an image displayed in at least one dim area.

16. The display apparatus of claim 9, wherein the processor determines a time period between the change of the first portion to the first dim area and the change of the second portion to the second dim area based on duration of the dim state.
